(19) United States
(12) Patent Application Publication
(10) Pub. No.: US 2013/0301563 A1
(43) Pub. Date: Nov. 14, 2013

(54) PILOT DESIGN FOR MILLIMETER WAVE BROADBAND

(71) Applicant: Samsung Electronics Co., Ltd, Suwon-si (KR)

(72) Inventors: Ankit Gupta, Redmond, WA (US); Zhouyue Pi, Allen, TX (US)

(73) Assignee: Samsung Electronics Co., Ltd, Suwon-si (KR)

(21) Appl. No.: 13/889,945

(22) Filed: May 8, 2013

Related U.S. Application Data
(60) Provisional application No. 61/646,108, filed on May 11, 2012.
(60) Provisional application No. 61/662,200, filed on Jun. 20, 2012.

(51) Int. Cl. H04L 5/00

(52) U.S. Cl. CPC H04L 5/0048
USPC 370/329

(57) ABSTRACT

A transmitter in a wireless network configured to utilize a pilot design and channel estimation strategy to reduce pilot overhead, the pilot design based on a channel decomposition of the channel in a ray tracing channel model. A method of using a three tiered pilot design in a millimeter wave broadband (MMB) wireless network to estimate channel state information (CSI) may include assigning a first tier pilot to a first set of resource blocks, assigning a second tier pilot to second set of resource blocks, assigning a third tier pilot in a third set of resource blocks. When two of the pilots are assigned to a common resource block, the lower tier pilot may be given preference over the higher tier pilot.

### CROSS-REFERENCE TO RELATED APPLICATION(S) AND CLAIM OF PRIORITY

The present application claims priority to U.S. Provisional Patent Application Ser. No. 61/646,108 filed May 11, 2012, entitled “Pilot Design For Spatial Channel Estimation In MMB” and U.S. Provisional Patent Application Ser. No. 61/662,200 filed Jun. 20, 2012, entitled “Multi-Tiered CSI Pilot Design For MMB”. The content of the above-identified patent documents is incorporated herein by reference.

### TECHNICAL FIELD

The present application relates generally to telephonic communications and, more specifically, to a signaling system for a millimeter wave broadband (MMB).

### BACKGROUND

In current cellular systems, a strategy to estimate the channel may be to transmit n_{T} pilots (one for each antenna) on orthogonal signals (whether frequency or code). Each such signal may be received at all receive (Rx) antennas and then separated so that the channel from each transmit (Tx) to each Rx can be independently estimated. In addition the pilots may be repeated in frequency, because the channel may be frequency selective.

### SUMMARY

Embodiments disclosed herein relate to a transmitter in a wireless network configured to utilize a pilot design and channel estimation strategy to reduce pilot overhead, the pilot design based on a channel decomposition of the channel in a ray tracing channel model.

Embodiments disclosed herein relate to a wireless network configured to transmit pilot signals in a resource block using a plurality of antennas, wherein the number of pilot signals in a resource block is less than the number of antennas used to transmit the pilot signals in the resource block.

Embodiments disclosed herein relate to a method of using a three tiered pilot design in a millimeter wave broadband (MMB) wireless network to estimate channel state information (CSI). The method may include assigning a first tier pilot to a first set of resource blocks, assigning a second tier pilot to second set of resource blocks, assigning a third tier pilot in a third set of resource blocks, wherein when two of the pilots are assigned to a common resource block, the lower tier pilot is given preference over the higher tier pilot. The method may also include transmitting each of the first tier pilot, the second tier pilot, and the third tier pilot to a user equipment.

Embodiments disclosed herein relate to a method of establishing a pilot structure between a base station and a UE. The method may include broadcasting from the base station information relating to the pilot structure, receiving the information at the user equipment, determining the pilot structure with the information broadcast from the base station, and returning CSI values from the user equipment to the base station.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a ray tracing channel model according to embodiments of the present disclosure;

FIG. 2 illustrates an architecture for millimeter wave broadband (MMB) according to embodiments of the present disclosure;

FIG. 3 illustrates an angle of arrival/angle of departure (AOA/AOD) estimation pilot illustration of (k, l, m) according to embodiments of the present disclosure;

FIG. 4 illustrates an AOA/AOD estimation pilot according to embodiments of the present disclosure;

FIG. 5 illustrates a flow chart of a base station and user equipment procedure for determining CSI values in MMB according to embodiments of the present disclosure;

FIG. 6 illustrates a flow chart of a base station and user equipment procedure for determining CSI values in MMB according to embodiments of the present disclosure;

FIG. 7 illustrates a flow chart of a base station and user equipment procedure for determining CSI values in MMB according to embodiments of the present disclosure;

FIG. 8 illustrates a flow chart of a base station and user equipment procedure for determining CSI values in MMB according to embodiments of the present disclosure;

FIG. 9 illustrates an AOD with user location according to an exemplary embodiment of the disclosure;

FIG. 10 illustrates a three tiered pilot structure for MMB according to embodiments of the present disclosure;

FIG. 11 illustrates a specific example of a three tiered pilot according to embodiments of the present disclosure;

FIG. 12 illustrates a flow chart of a base station and user equipment procedure for determining CSI values in MMB according to embodiments of the present disclosure

FIG. 13 illustrates a flow chart of a base station and user equipment procedure for determining CSI values in MMB according to embodiments of the present disclosure; and

FIG. 14 illustrates a flow chart of a base station and user equipment procedure for determining CSI values in MMB according to embodiments of the present disclosure;

FIG. 15 illustrates a wireless network according to an embodiment of the present disclosure;

FIG. 16A illustrates a high-level diagram of a wireless transmit path according to an embodiment of this disclosure;

FIG. 16B illustrates a high-level diagram of a wireless receive path according to an embodiment of this disclosure; and

FIG. 17 illustrates a subscriber station according to an exemplary embodiment of the disclosure

### DETAILED DESCRIPTION

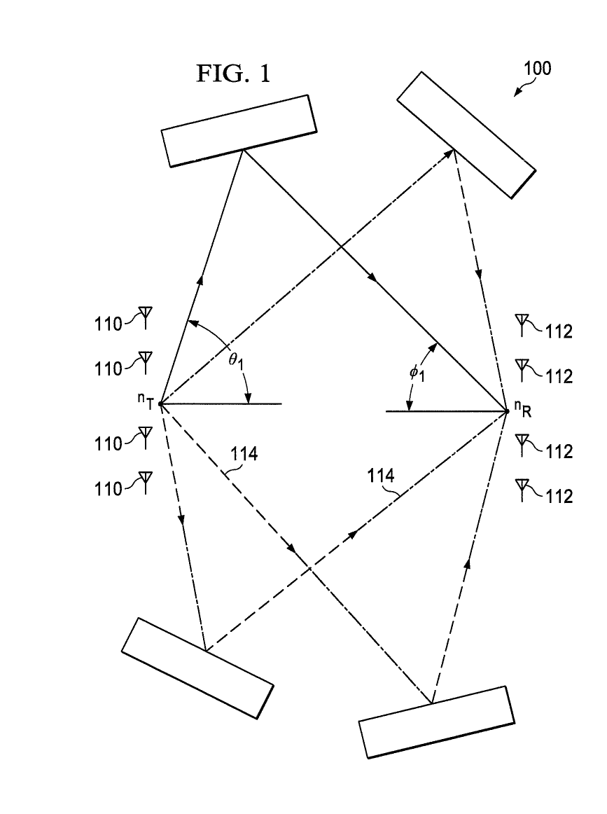

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged telecommunications system.

The following three documents and standards descriptions are hereby incorporated into the present disclosure as if fully set forth herein:

Reference 1 (REF1): 3GPP TS 36.211 LTE Physical channels and modulation, v. 10;

Reference 2 (REF2): “Millimeter wave propagation: Spectrum management implications”, Federal Communications Commission, Office of Engineering and Technology, Bulletin Number 70, July, 1997; and

Reference 3 (REF3): Zhouyue Pi, Farooq Khan, “An introduction to millimeter-wave mobile broadband systems”, IEEE Communications Magazine, June 2011.

FIG. 1 illustrates a ray tracing channel model according to embodiments of the present disclosure. The embodiment of the ray tracing channel model shown in FIG. 1 is for illustration only. Other embodiments could be used without departing from the scope of this disclosure.

A cellular system 100 includes n_{T} transmit antennas 110, n_{R} receive antennas 112 and p paths 114. In current cellular systems (REF1), a strategy to estimate the channel may be to transmit n_{T} pilots (one for each antenna) on orthogonal signals (whether frequency or code). Each such signal may be received at all Rx antennas 110, and then separated so that the channel from each Tx to each Rx can be independently estimated. In addition the pilots may be repeated in frequency, because the channel may be frequency selective. For large number of antennas at the base station and mobile station, the problem of channel estimation and feedback may be magnified.

Due to a lack of available spectrum in the low frequencies one option may be to use frequencies that are an order of magnitude higher than current cellular frequencies as proposed in millimeter wave broadband (REF2, and REF3). For electromagnetic radiation the path loss is inversely proportional to the square of the frequency. To make MMB feasible this path loss may be countered by using very large arrays of antennas at the receiver and transmitter in order to achieve beamforming gain.

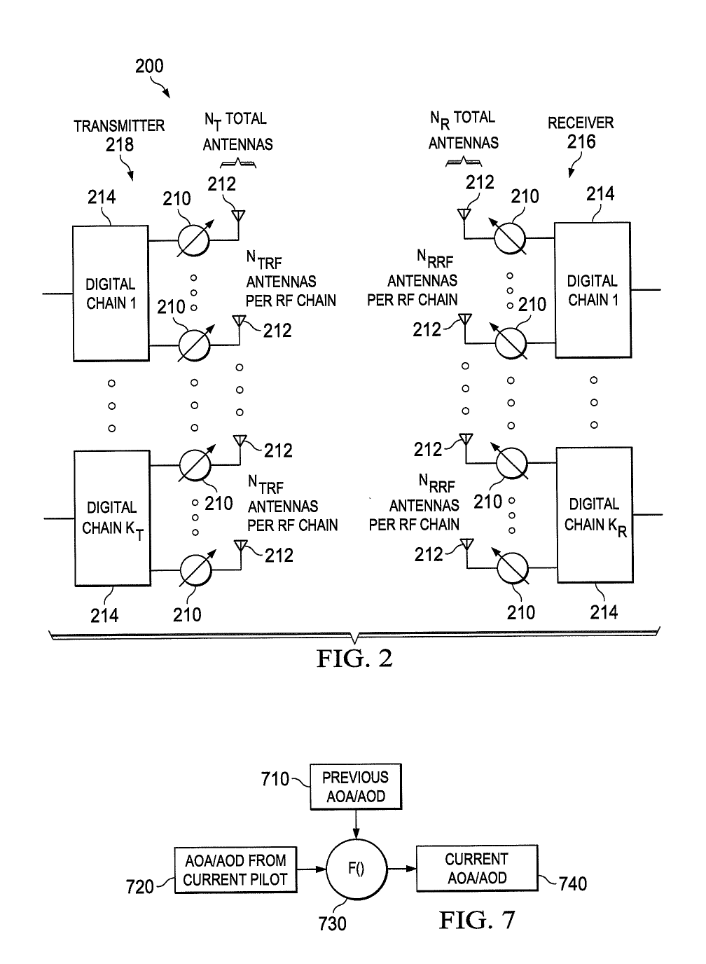

FIG. 2 illustrates an architecture for millimeter wave broadband (MMB) according to embodiments of the present disclosure. The embodiment of the MMB architecture shown in FIG. 2 is for illustration only. Other embodiments could be used without departing from the scope of this disclosure.

Driving large antenna arrays by using a separate baseband chain for each antenna may be complex and expensive. An architecture in MMB is illustrated in FIG. 2. This MMB architecture 200 may use low cost analog phase shifters 210 in front of each antenna 212, and multiple antennas 212 may be fed signal from only one digital (baseband) chain 214. We assume that we have K_{T}, K_{R} digital chains 214 at the receiver 216 and transmitter 218 respectively. Each of the chains 214 at the transmitter 218 is connected to NTRF antennas 212 and the receiver is connected to NRRF antennas 212.

For a system like the one illustrated in FIG. 2, there may be at least two issues with the commonly used strategy for pilot transmission. One is that there is a humongous number of antennas 212. Therefore, transmission of n_{T} pilots per RB is a lot of overhead. Assume that we have the same number of REs per RB as in LTE. Then if we have 128 antennas at the transmitter, then we need to have 128 pilots per RB, while REs per RBs is 144. Such an approach will use almost all of the resources for pilot transmission and hence is clearly infeasible.

Another issue is that the MMB architecture 200 shown in FIG. 2 in which multiple antennas 212 are driven by one digital chain 214 restricts our freedom to transmit orthogonal signals in frequency. A different approach than the one currently used is therefore necessary.

An alternative pilot design and channel estimation strategy may substantially reduce the pilot overhead. This pilot design is based on the channel decomposition of the channel in FIG. 1 as shown in Equation 1a:

$$H = [ \begin{matrix}1 & 1 & … & 1 \\ {e}^{j {θ}_{1}} & {e}^{j {θ}_{2}} & … & {e}^{j {θ}_{p}} \\ ⋮ & ⋮ & ⋮ & ⋮ \\ {e}^{( {n}_{R} - 1 ) j {θ}_{1}} & {e}^{( {n}_{R} - 1 ) j {θ}_{2}} & … & {e}^{( {n}_{R} - 1 ) j {θ}_{P}}\end{matrix} ] [ \begin{matrix}{h}_{1} & 0 & … & 0 \\ 0 & {h}_{2} & … & 0 \\ ⋮ & ⋮ & ⋮ & ⋮ \\ 0 & 0 & … & {h}_{p}\end{matrix} ] [ \begin{matrix}1 & {e}^{j {θ}_{1}} & … & {e}^{( {n}_{t} - 1 ) j {θ}_{1}} \\ 1 & {e}^{j {θ}_{2}} & … & {e}^{( {n}_{t} - 1 ) j {θ}_{2}} \\ ⋮ & ⋮ & ⋮ & ⋮ \\ 1 & {e}^{j {θ}_{p}} & … & {e}^{( {n}_{t} - 1 ) j {θ}_{p}}\end{matrix} ] \qquad ( 1 a )$$

In this representation of the channel, the number of variables is equal to 3p, as opposed to n_{R}×n_{T}. If the number of paths is much less than n_{T}×n_{R} then it is advantageous to send a pilot signal enough times to estimate the 3p parameters as opposed to estimating the full n_{R}×n_{T} components of the H matrix individually.

In general, even a non MMB system using a pilot design in which the overhead scales as n_{T} may be problematic because with increase in the number of antennas, there may be not only the power gain from beamforming (and capacity gain from SDMA) but also the loss incurred from pilot overhead. At some point these two may cancel each other out, putting a limit on the number of antennas that can be used and the maximum gains that can be realized. However, if we were to characterize the channel in terms of the number of paths, then the beamforming and SDMA gains could be potentially unbounded by increasing the number of Tx antennas.

Observing the spatial channel model it is clear that a small number of variables (3p) may fully determine the system, even if we keep on adding new antennas at the base station and the mobile station. Therefore the pilot overhead may not scale with the number of antennas at the BS and MS for any communication system, but should be limited by the number of paths. In other words, even if current designs may be based on separate pilots for each transmit antennas, in MMB systems with the use of large number of antennas to increase channel capacity, even at lower frequencies, pilots may have to be designed to be limited by the number of paths and not scale with the number of Tx antennas.

In certain embodiments of this disclosure, a pilot is designed to estimate the spatial characteristic of the channel viz. the angles of arrival and the angles of departures for each path from the BS to UE. Being spatial characteristics angle of arrivals and departures may be invariant across frequency. Therefore the spatial pilot may not require frequent repetition across frequency.

It can be assumed that an upper bound on P on the number of paths p is known. This upper bound is cell specific. A rural cell may have P=2, while an urban cell may have P as large as 10.

The received signal may be given as according to Equation 1b.

y=F_{RRF}HF_{TRF}s+n (1b)

Where F_{RRF}, F_{TRF} are block diagonal matrices, where each block of F_{RRF} is of size 1×N_{RRF}, and the i^{th} block consists of the phases used in the i^{th} digital chain 214 in FIG. 2. Similarly each block of F_{TRF} is of size N_{TRF}×1 and the i^{th} block may essentially consist of the phases used in the i^{th} digital chain 214 in FIG. 2. As discussed before the number of independent variables that determine H may be at most 3P.

To estimate AOA and AOD, 3P parameters may need to be extracted, as may follow from the observation in Equation 1b. To estimate 3P parameters we may need 3P equations. However the number of equations in Equation 1b is equal to K_{R}. Embodiments of the present disclosure describe how the pilot is transmitted to augment the equations to be greater than or equal to 3P. In contrast to traditional pilot design schemes, this scheme also may require varying the receive and transmit precoders to achieve the desired number of equations for the 3P variables.

In the procedure below, the number of independent equations can be successively augmented. In each of the augmentation steps, an observation of the form LHR is obtained. For example initially in Equation 1b L=F_{RRF}, and R=F_{TRF}×s. The number of equations in such an observation is equal to rows(L)×Cols(R), assuming L and R are full rank. If L or R are not full rank then the number of equations is reduced, for example if some of the rows of L are linear combinations of others, then the equations corresponding to these rows are linear combination of the equations corresponding to other rows and hence not independent, thus it may be desirable to augment the number of equations in a manner so that L and R are full rank.

The pilot design may follow three stages which are explained below:

Stage I: Vary pilot across frequency

In certain embodiments, the transmitter transmits pilots [s₁, . . . , sₖ]. Here, the input output representation becomes:

[y₁, . . . , yₖ]=F_{RRF}HF_{TRF}[s₁, . . . , sₖ]+[n₁, . . . , nₖ] (1c)

This step augments the number of equation to K_{R}×k.

In one embodiment the transmitter transmits pilots [s₁, . . . , s_{K}_{_{T}}], which are orthogonal. Here, the input output representation becomes.

[y₁, . . . , y_{K}_{_{T}}]=F_{RRF}HF_{TRF}[s₁, . . . , s_{K}_{_{T}}]+[n₁, . . . , n_{K}_{_{T]}} (1d)

Let S=[s₁, . . . , s_{K}_{_{T}}], by post-multiplying both sides with S^{H}, the equation may be represented as shown in Equation 2:

[y₁, . . . , y_{K}_{_{T}}][s₁, . . . , s_{K}_{_{T}}]^{H}=F_{RRF}HF_{TRF}+[n′₁, . . . , n′_{K}_{_{T]}} (2)

Here, Y_{I}=[y₁, . . . , y_{K}_{_{T}}][s₁, . . . , s_{K}_{_{T}}]^{H}, where I stands for the first stage. The orthonormal choice of [s₁, . . . , s_{K}_{_{T}}] ensures that the noise is still i.i.d. This choice of pilot thus ensures that we have an observation of the form Equation 2 irrespective of the pilot choice (for example if the pilot hops across different values). This ensures a consistent detection problem at the UE and simplifies its receiver algorithm and implementation.

Stage II: Repeat Stage I in time: (fixed F_{TRF} varying F_{RRF}). The second augmentation step is to increase the number of rows in L as discussed above. In the second stage, F_{TRF} is maintained as fixed and F_{RRF} is varied l times in time, with which the stacked equation 3 is obtained:

$$[ \begin{matrix}{Y}_{I} ( 1 ) \\ ⋮ \\ {Y}_{I} ( l )\end{matrix} ] = [ \begin{matrix}{F}_{RRF ( 1 )} \\ ⋮ \\ {F}_{RRF ( l )}\end{matrix} ] {HF}_{TRF} + [ \begin{matrix}{N}_{I} ( 1 ) \\ ⋮ \\ {N}_{I} ( l )\end{matrix} ] \qquad ( 3 )$$

Note that in the second stage the only base station procedure is to keep F_{TRF} fixed. It is up to the receiver to vary F_{RRF} to be able to augment the number of rows in the L matrix. Further note that the rows of Equation 3 can be permuted in a manner so that the first row of the matrices F_{RRF}(i) are together, then the second rows are together, and so on. This can be achieved by multiplying both sides by a square permutation matrix P₁. Which does not have any effect on the statistical properties of the noise. However the resulting matrix:

$${F}_{P} = P [ \begin{matrix}{F}_{RRF ( 1 )} \\ ⋮ \\ {F}_{RRF ( l )}\end{matrix} ] , \qquad ( 4 )$$

is block diagonal, with each block of size l×NRRF. Further the receiver can choose F_{RRF}, in such a fashion that the, rows are linearly independent for each block diagonal matrix, or equivalently each block diagonal element is full rank. Any choice of linearly independent rows may be used.

In certain embodiments, a fixed set of orthogonal rows is used by the UE for the F_{RRF} components in Fₚ. In one embodiment the UE hops across various choice of F_{RRF}.

Stage III: Repeat Stage II in time: vary F_{TRF}: the pilot is repeated in stage I and II, for various F_{TRF}. After stage II the number of equation is equal to l×k×K_{R}. F_{TRF} is varied so as to make the total number of equations equal to 3P. Therefore an additional repetition of

$$\frac{3 P}{l \times {K}_{R} \times k}$$

is required. In general, the number of times Stage III is repeated is denoted as m. Repeating steps I and II for m values of F_{TRF}, the observations as can be written as:

[Y_{II}(1), . . . , Y_{II(m)}]=FₚH[F_{TRF}(1), . . . , F_{TRF}(m)]+[N₁, . . . , Nₘ] (5)

As before a permutation matrix post-multiplying both sides will permute the columns of F=[F_{TRF}(1), . . . , F_{TRF}(m)], so that it becomes block diagonal. It is a sensible choice choose the columns such that they are linearly independent, otherwise some of the columns of F are linear combination of others and thus redundant.

In certain embodiments, a fixed set of orthogonal columns is used by the BS for the component in F_{TRF}(i). In one embodiment, the BS hops across various choice of F_{TRF}.

Finally the number of pilots are given as follows:

### Pilots in Frequency: k;

### Pilots in Time: 1×m; and

Total Pilots overhead: (k×1×m).

To recover 3P variables the pilot overhead is equal to

$$\frac{3 P}{{K}_{R}} .$$

Note that this pilot overhead is for all of the subbands. Since AOA/AOD is a spatial characteristic it remains unchanged over the entire subband, and this pilot could be transmitted in the center RE, or repeated sparsely over the frequency if so desired. Thus the pilot overhead over a large band is vanishingly small.

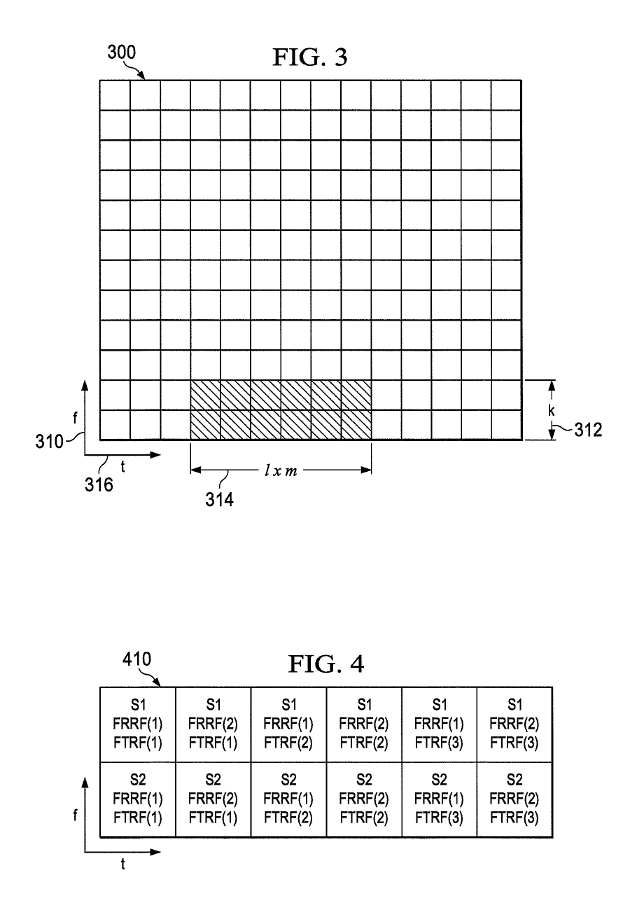

FIG. 3 illustrates an angle of arrival/angle of departure (AOA/AOD) estimation pilot illustration of (k, l, m) according to embodiments of the present disclosure.

FIG. 4 illustrates an AOA/AOD estimation pilot according to embodiments of the present disclosure. The embodiments of the AOA/AOD estimation shown in FIGS. 3 and 4 are for illustration only. Other embodiments could be used without departing from the scope of this disclosure.

Below is described an example of the design disclosed above. This example pilot design is shown in FIG. 3, and shown in more detail in FIG. 4. Many alternatives are possible, and this example is chosen among the many alternatives merely to serve as a illustrative example, and should not be construed as limiting or preferred over other examples. Assume there is an 8 Tx, 4 Rx system with 2 Rf chains at the transmitter and one at the receiver, and an upper bound on the number of paths equal to 4.

Stage I: Since K_{T} 310 is equal to 2 we send two pilots in frequency 312.

Stage II: We choose l=2, note that this is minimum required to preserve the AOA information. “1×m” 314 is shown in FIG. 3 along the time axis 316.

Stage III: m=3 is chosen to ensure that k×l×m×K_{R} is greater than 3P or 12 as shown in the shaded region 318 in FIG. 3. In the example shown in FIG. 4, 12 pilots 140 with are shown with the enumeration of each of the indices.

Several other embodiments based upon the pilot design proposed herein are as follows.

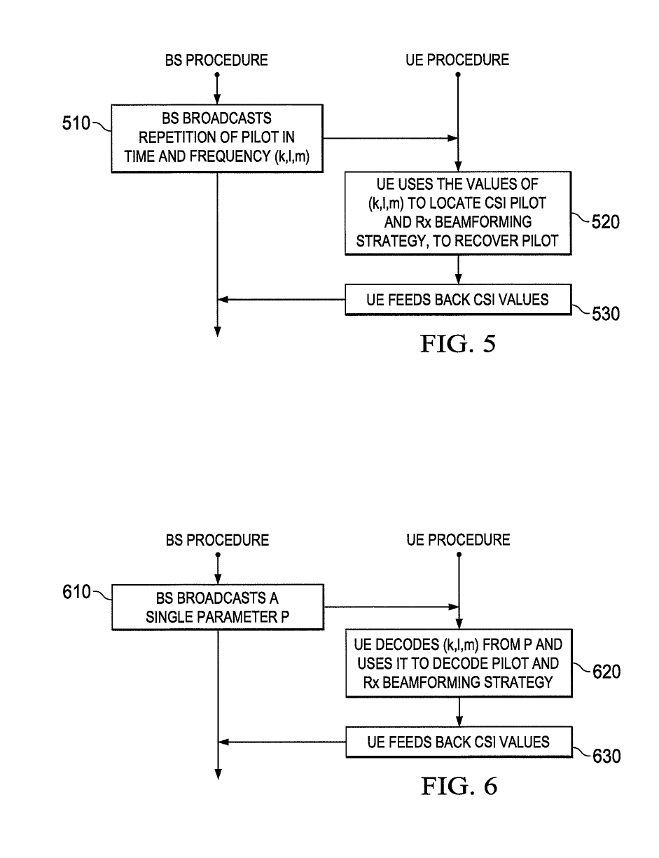

FIG. 5 illustrates a flow chart of a base station and user equipment procedure for determining CSI values in MMB according to embodiments of the present disclosure. The embodiment of the process shown in FIG. 5 is for illustration only. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In some embodiments, the values k, l and m or the number of repetitions of the three stages are cell specific in a particular cell and can be conveyed to the UEs in a broadcast message at 510. The broadcast message can be transmitted for example through the PBCH or PDCCH. This procedure is illustrated in FIG. 5.

FIG. 6 illustrates a flow chart of a base station and user equipment procedure for determining CSI values in MMB according to embodiments of the present disclosure. The embodiment of the process shown in FIG. 6 is for illustration only. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In some embodiments, the values of (k, l, m) can be implicitly described by a single number P (which can be the proxy for number of paths in a system), as in the example given above. The base station can broadcast this value at 610 to all the UEs. The UEs then decode the values of k, l and m at 620. Thereafter, the UEs proceed to decode the pilot and report back CSI at 630.

In some embodiments, the values of F_{RRF}(i) and F_{TRF}(j) can be pre-specified, such as stored in a memory, and must be adhered to by the UE and base station. The UE can signal the values of k, l, and m by the base station. The UE then knows the pilot structure. It also knows the value of F_{TRF}(i) iε{1, . . . m} and F_{RRF}(i) Iε{1, . . . , l}. Both of these values could be base station or UE specific.

In some embodiments, the values of F_{RRF}(i) may depend upon the UE id, and the Cell id. The values are cycled through based on a hopping pattern. This is to ensure that no particular spatial configuration always elicits a worst case performance in a given UE. In other words, the hopping pattern ensures that the worst case performance gets amortized over all the UEs. In some embodiments, the values of F_{TRF}(i) depends upon the Cell id and cycle on a hopping pattern. This is to again ensure that no particular spatial configuration elicits a worst case performance in the cell.

In some embodiments, the AOA/AOD pilot location is spread out across the frequency band at uniform intervals; the repetition of the pilot in frequency is specified by an additional parameter r broadcast by the base station.

FIG. 7 illustrates a flow chart of a base station and user equipment procedure for determining CSI values in MMB according to embodiments of the present disclosure. The embodiment of the process shown in FIG. 7 is for illustration only. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In some embodiments, the UE uses previously detected AOA and AOD's at 710 in conjunction with the current AOA and AOD at 720. The UE then combines them with an appropriate function at 730. The UE calculates the current AOA/AOD at 740. This approach reduces the noise by taking into account the fact that AOA and AOD are slow changing characteristics of the channel. An example of this could be:

θᵢ(t)=(1−α)θᵢ(t−1)+α\hat{θ}ᵢ (6)

Where \hat{θ}ᵢ is the currently detected AOA (or AOD) and θᵢ(t) is the estimate AOA (or AOD) at time t.

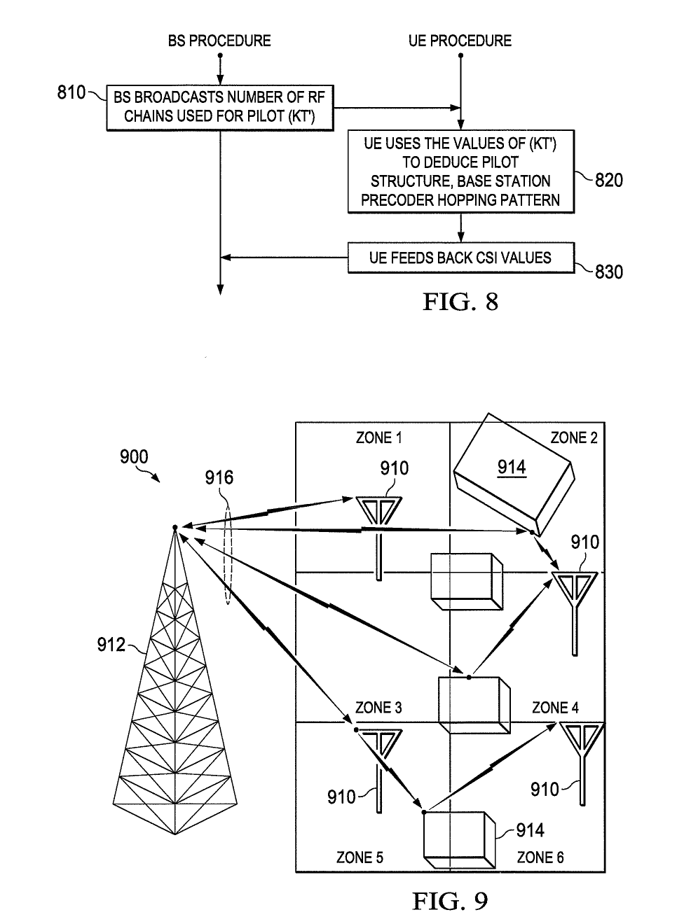

FIG. 8 illustrates a flow chart of a base station and user equipment procedure for determining CSI values in MMB according to embodiments of the present disclosure. The embodiment of the process shown in FIG. 8 is for illustration only. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In some embodiments, the base station does not need to use all K_{T} of its digital chains to transmit the pilot. In fact it a RF chain is used for pilot then it fixes the RF beamforming weights for that OFDM symbol. Hence the base station can select to use only K_{T}′<K_{T} RF chains for pilot transmission. The parameter K_{T}′ can be implicitly factored in the pilot design and placement, for example F_{TRF} could be selected from a table that varies with the number of RF chains used for pilot transmission. Referring to FIG. 8, the base station broadcasts number of RF chains used for pilot (K_{T}′) at 810. The UE uses the values of (K_{T}′) to deduce pilot structure and base station precoder hopping pattern. At 830, the UE feeds back CSI values to the base station. In some embodiments, the base station uses the RF beamforming weights in accordance with a priori knowledge about the paths in the system. For example, the base station can know that there are strong reflectors between a pair of angles. Then the BS chooses the RF beamforming weights so that the paths between these two angles are strengthened. The base station coveys the values of F_{TRF} it proposes to use to the UEs in a broadcast message, possibly on the data channel.

In some embodiments, the base station choose F_{TRF} and F_{RRF} such that the matrix LA(θ)ΓB(□)R always has a simple structure. As described earlier the matrices L and R are block diagonal. Suppose we choose F_{TRF} and F_{RRF} in such a manner that the block diagonal elements are the same. These block diagonal elements are of size NTRF×m and NRRF×l respectively, suppose l and m are chosen such that NTRF=m×a and NRRF=l×b, where a and b are integers. Then block diagonal elements in L are such that there are l orthogonal columns which then repeat for b, times and similarly the block diagonal elements of R are such that there are m orthogonal rows which then repeat a times. The observation is given as:

y=LAΓBR+N (7)

If F₁ is denoted as the set of unique columns in L, and F₂ as the set of unique rows in R. Then postmultiplying (4) by F₂^{H} and premultiplying by F₁^{H}, Equation 8 is obtained:

y′=A′Γ′B′+N′ (8)

Where A′ has the same structure as A albeit with reduced rows (

$$\frac{{n}_{R}}{b}$$

instead of n_{R}), Similarly B has same structure as B′ albeit with reduced rows (

$$\frac{{n}_{T}}{a}$$

instead of n_{T}). Similar Γ′ is a p×p diagonal matrix.

This method of pilot design ensures that a single algorithm for AOA/AOD detection (parameterized by l and m) can be implemented and used in the mobile station, instead of having to solve a new problem that depends upon L and R.

For MMB communications spatial channel estimation is of key importance to enable SDMA, beamforming etc. Conventional pilot design (as in LTE) is infeasible and wasteful for large number of antennas. The proposed pilot structure incurs minimal overhead while being able to estimate the key components of the channel. In some embodiments, a multi-tiered approach may be taken. The channel matrix can be decomposed in as follows:

H=A(θ₁, . . . , θₚ)Γ(h₁, . . . , hₚ)B(φ₁, . . . , φₚ, (9)

where A(θ₁, . . . , θₚ) and B(φ₁, . . . , φₚ) are spatial characteristics and hence invariant across frequency. The only frequency varying component in the channel is the matrix Γ(h₁, . . . , hₚ).

FIG. 9 illustrates an AOD with user location according to embodiment of the disclosure. The embodiments of the AOD with user location shown in FIG. 9 is for illustration only. Other embodiments could be used without departing from the scope of this disclosure.

The three components A, B and Γ have different rate of change both across frequency and time. A and B are spatial characteristics and hence constant across frequency. While Γ is frequency dependent. In time the angles of arrival (A) can change much faster than the angles of departure (B). This is because the angles of departures that reach a certain UE in a certain position only change when the UE position changes by a large amount. This is illustrated in FIG. 9, which shows a number of users 910 near a base station 912 with several reflectors in various paths 916. When the distances between the base station 912 and the UEs are large, the AOD remain the same. However the AOA can change when the user rotates, which could be much faster than the change of AOD. However the reflection coefficients hᵢ can change even if the user moves by half a wavelength and thus they are the fastest changing of all.

In some embodiments, a three tiered pilot design approach may be used to estimate the CSI, based on these three components A, B and Γ. The first tier pilot is meant to estimate all three together and thus requires many resources (i.e. it must contain enough redundancy to estimate 3p variables). The second tier pilot assumes that AODs are known and only seeks to estimate A and Γ (thus it needs sufficient redundancy to estimate 2p variables). The third tier pilot assumes knowledge of both A and B and just seeks to estimate Γ (Thus it requires to just estimate p variables).

These three tiers of pilots may also differ in how frequently they must be repeated. For example the first tier pilot may need to be much less frequent than the second tier pilot which in turn must be less frequent than the third tier pilot. Also note that only the component Γ varies across frequency, while A and B being spatial characteristics are more or less constant across frequency. Therefore the first and second tier pilots only need very sparse repetition (if at all across) frequency, while the third tier pilot must be repeated frequently across frequency.

For ease of notation we will henceforth refer to these three tiers of pilots as follows:

Tier I Pilot=AOD pilot.

Tier II Pilot=AOA pilot

Tier III Pilot=CSI Pilot.

Note that the nomenclature indicates what the principal function of the pilot is. Thus the tier I pilot may not only yield AODs, it also yields AOAs and per path CQI as well. However, its main purpose is to get the AODs and hence it is termed the AOD pilot.

The received signal for each RE may be represented as in Equation 3A as follows.

y=F_{RRF}HF_{TRF}s+n (3A)

Each of these pilots may need to be constructed in a manner in space and time so that the desired number of parameters can be extracted from Equation 3A. The following procedure describes a way to augment the number of equations so that any desired M variables can be estimated. Given an upper bound on the number of paths P, the value of M for the AOD, AOA and CSI pilot may be set equal to 3P, 2P and P respectively.

Pilot Structure based on the number of variables M to be estimated:

The received signal can be given in Equation 3A above. Where F_{RRF}, F_{TRF} are block diagonal matrices, where each block of F_{RRF} is of size 1×N_{RRF}, and the i^{th} block consists of the phases used in the i^{th} digital chain in FIG. 2. Similarly each block of F_{TRF} is of size N_{TRF}×1 and the i^{th} block essentially consists of the phases used in the i^{th} digital chain in FIG. 2. At most M equations need to be extracted out of Equation 3A.

Below is an explanation of another exemplary embodiment.

To estimate M variables M equations need to be created from the observation in Equation 9. However, the number of equations in Equation 9 is equal to K_{R}. The pilot is transmitted to augment the equations to be greater than or equal to M. In contrast to traditional pilot design schemes, this scheme also requires varying the receive and transmit precoders to achieve the desired number of equations for the M variables.

In the procedure below the number of independent equations can be successively augmented. In each of the augmentation steps, an observation of the form LHR is obtained. For example initially in Equation 9 L=F_{RRF}, and R=F_{TRF}×s. The number of equations in such an observation may be equal to rows(L)×Cols(R), assuming L and R are full rank. If L or R are not full rank then the number of equations may be reduced, for example if some of the rows of L are linear combinations of others, then the equations corresponding to these rows are linear combination of the equations corresponding to other rows and hence not independent, thus it is desirable to augment the number of equations in a manner so that L and R are full rank.

The pilot design follows three stages which are explained below:

Stage I: Vary pilot across frequency

The transmitter may transmit pilots [s₁, . . . , sₖ]. With this the input output representation may be represented as:

[y₁, . . . , yₖ]=F_{RRF}HF_{TRF}[s₁, . . . , sₖ]+[n₁, . . . , nₖ]

This step augments the number of equation to K_{R}×k.

Stage II: Repeat Stage I in time: (fixed F_{TRF} varying F_{RRF}). The second augmentation step may increase the number of rows in L as discussed above. In the second stage, F_{TRF} can remain fixed and F_{RRF} can vary l times in time, with which the stacked equation 10 is obtained:

$$[ \begin{matrix}{Y}_{I} ( 1 ) \\ ⋮ \\ {Y}_{I} ( l )\end{matrix} ] = [ \begin{matrix}{F}_{RRF ( 1 )} \\ ⋮ \\ {F}_{RRF ( l )}\end{matrix} ] {HF}_{TRF} [ {s}_{1} , … , {s}_{k} ] + [ \begin{matrix}{N}_{I} ( 1 ) \\ ⋮ \\ {N}_{I} ( l )\end{matrix} ] \qquad ( 10 )$$

Note that in the second stage the only base station procedure is to keep F_{TRF} fixed. It is up to the receiver to vary F_{RRF} to be able to augment the number of rows in the L matrix.

Stage III: Repeat Stage II in time: vary F_{TRF}: the pilot in stage I and II may be repeated for various F_{TRF}. After stage II the number of equation is equal to l×k×K_{R}. We now vary F_{TRF}, so as to make the total number of equations equal to 3P. Therefore an additional repetition of at least

$$\frac{3 P}{l \times {K}_{R} \times k}$$

is required. In general we denote the number of times Stage III is repeated as m. Repeating steps I and II for m values of F_{TRF} the observations can be written as Equation 11:

$$[ {Y}_{II} ( 1 ) , … , {Y}_{II ( m )} ] = [ \begin{matrix}{F}_{RRF ( 1 )} \\ ⋮ \\ {F}_{RRF ( l )}\end{matrix} ] H [ {F}_{TRF} ( 1 ) [ {s}_{1} , … , {s}_{k} ] , … , {F}_{TRF} ( m ) [ {s}_{1} , … , {s}_{k} ] ] + [ {N}_{1} , … , {N}_{m} ] \qquad ( 11 )$$

As before, a permutation matrix post-multiplying both sides will permute the columns of F=[F_{TRF}(1), . . . , F_{TRF}(m)], so that it becomes block diagonal. It may be sensible to choose the columns such that they are linearly independent, otherwise some of the columns of F are linear combination of others and thus redundant.

Finally the number of pilots are given as follows:

Pilots in Frequency: k

Pilots in Time: l×m

Total Pilots overhead: (k×l×m).

To recover M variables the pilot overhead is equal to

$$\frac{M}{{K}_{R}} .$$

Returning to the three tier design, the pilot structure of each tier is specified by the six numbers (f, t, b, k, l, m).

Where f and t are the periodicity in frequency and time respectively, while b is location of the first RE of the pilot. The parameter k, l and m determine how many symbols of the pilot are present.

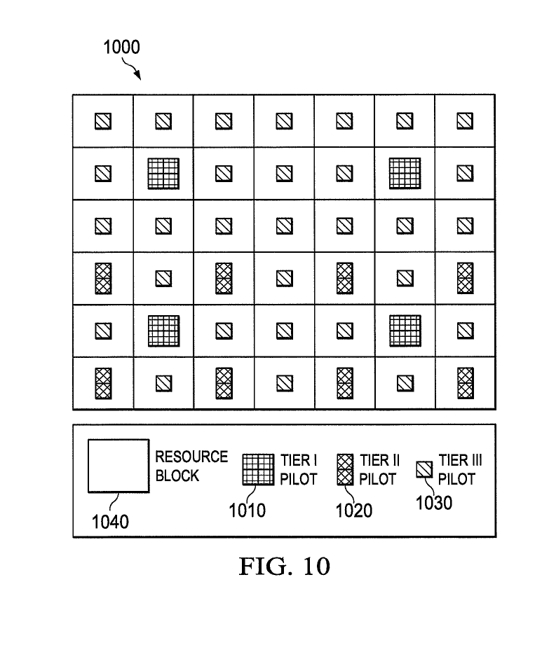

FIG. 10 illustrates a three tiered pilot structure for MMB according to embodiments of the present disclosure. The embodiment of the three tiered pilot structure for MMB shown in FIG. 10 is for illustration only. Other embodiments could be used without departing from the scope of this disclosure.

FIG. 10 illustrates the three tiered design and also illustrates that the AOD pilot 1010 has the most number of resources, but is the sparsest in terms of repetitions within resource blocks 1040, while the CQI pilot 1030 may be the most frequently repeated but it has the least number of resources allocated for each individual instance. The AOA pilot 1020 is a tier two pilot and falls between the AOA pilot 1010 and CQI pilot 1030.

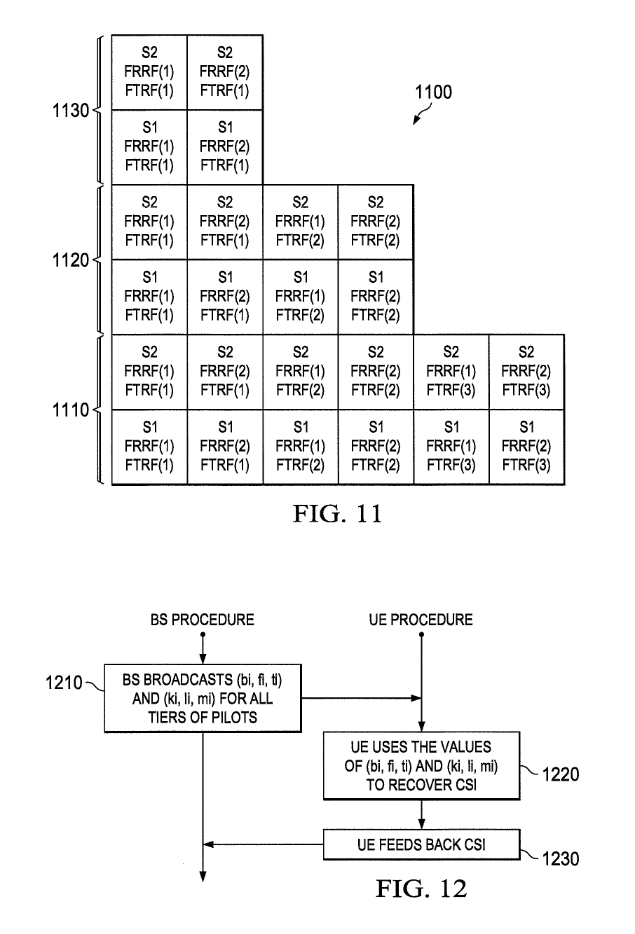

FIG. 11 illustrates a specific example of a three tiered pilot according to embodiments of the present disclosure. The embodiment of the three tiered pilot shown in FIG. 11 is for illustration only. Other embodiments could be used without departing from the scope of this disclosure.

Below is described an example of the design disclosed above. This example pilot design is shown in FIG. 10, and shown in more detail in FIG. 11. Many alternatives are possible, and this example is chosen among the many alternatives merely to serve as an illustrative example, and should not be construed as limiting or preferred over other examples.

Assume we have 8Tx, 4Rx system 2 Rf chains at the transmitter and one at the receiver, and an upper bound on the number of paths equal to 4.

AOD pilot 1110

In this case 3P/K_{R}=12 We choose k=2, l=2 and m=3.

AOA pilot 1120

We have 2P/K_{R}=8. We choose k=2, l=2 and m=2.

CQI Pilot 1130

Since P/K_{R}=4. We choose k=2, l=2, m=1.

Note that the RF precoders can be chosen to align in time. This may be necessary if the same antennas are used for multiple pilots, since the RF beamforming weights are fixed for the whole OFDM symbol. Note that FIG. 11 just shows one instance of each pilot, further the pilots are put together for ease of visualization. In general the CQI pilot will be frequent across the band, and in one RB only one of these pilots will be present (as in FIG. 10).

In some embodiments, when two pilots collide in the same time frequency resource, the lower tier pilot may be placed in favor of the higher tier one. This does not cause any problems in channel estimation because the AOD pilot contains sufficient information to give us both AOA and the CQI per path. Similarly the AOA pilot contains enough data to both decode the AOA as well as the CQI per path. Thus it may be a sensible approach to puncture a lower tier pilot in favor of a higher tier one. This is also illustrated in FIG. 10, wherein the CQI pilot 130 is punctured in favor of the AOD pilot 1020 or AOA pilot 1030.

FIG. 12 illustrates a flow chart of a base station and user equipment procedure for determining CSI values in MMB according to embodiments of the present disclosure. The embodiment of the process shown in FIG. 12 is for illustration only. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In some embodiments, the base station specifies three frequencies, and these can be repetitions of the three tiered pilots at 1210. For each of these we may have a beginning and a period (b₁, f₁, t₁), (b₂, f₂, t₂) and (b₃, f₃, t₃) respectively. Further, for the pilot in each tier, there can be three stage parameters (k, l, m) as described above. In a baseline embodiment the base station transmits all these parameters at 1210. These parameters can be put in a broadcast message which can be either put in the PDCCH, PDSCH or PBCH. The UE then uses the values of (bᵢ, fᵢ, tᵢ) and (kᵢ, lᵢ, mᵢ) to recover CSI at 1220. The UE would then feed back the CSI at 1230.

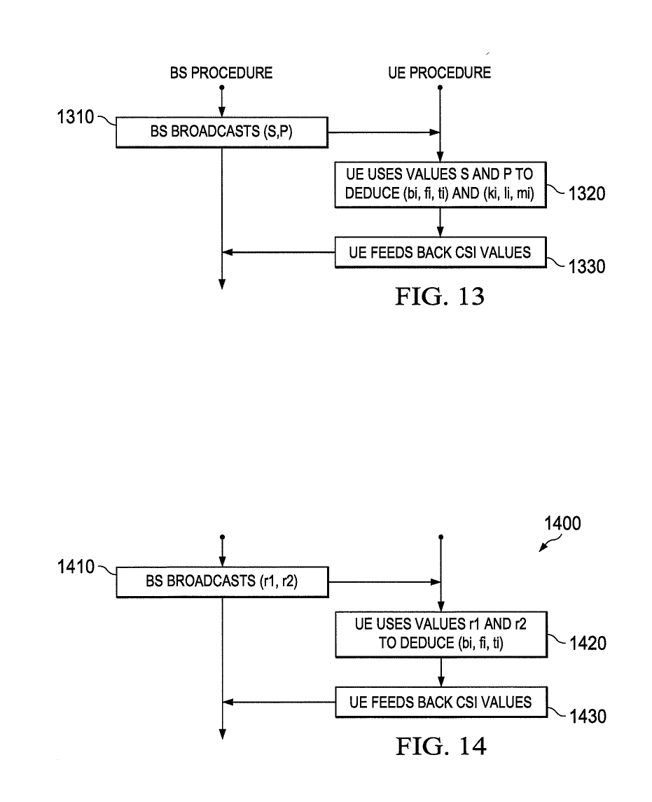

FIG. 13 illustrates a flow chart of a base station and user equipment procedure for determining CSI values in MMB according to embodiments of the present disclosure. The embodiment of the process shown in FIG. 13 is for illustration only. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

In some embodiments, the base station may specify a small list of parameters in the cell which is then used to deduce the quantities (b, f, t) by the mobile stations. For example it could specify a parameter P which is an upper bound on the number of paths in the channel and a parameter S, which is a proxy for the selectivity of the channel, at 1310. These two parameters then determine the values of (k, l, m) for each of the pilots and how frequently do the pilots repeat in frequency at 1320. For example there could be three levels of the parameters P and S, and the base station just needs to send 2 bits each to convey these levels.

In some embodiments, the CSI pilot is chosen so that the required analog beamforming at Tx and Rx coincide in time. This pilot structure ensures that the same RF chain can be used to form the desired beam (because a beam is fixed from one RF chain in one OFDM symbol).

FIG. 14 illustrates a flow chart of a base station and user equipment procedure for determining CSI values in MMB according to embodiments of the present disclosure. The embodiment of the process shown in FIG. 14 is for illustration only. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The process depicted in the example depicted is implemented by a transmitter chain in, for example, a mobile station.

Referring to FIG. 14, in some embodiments, the beginning point of each pilot may be the same. Let the repetition period of the CQI pilot be equal to (f_{CQI}, t_{CQI}), then the repetition period (f_{AOA}, t_{AOA}) may be a multiple of the CQI pilot and the repetition period of the AOD pilot (f_{AOD}, t_{AOD}) may be a multiple of the AOA pilot. With the understanding that whenever the AOA pilot occurs the CQI pilot is not present and whenever the AOD pilot occurs the AOA pilot is not present, or in other words the pilots puncture each other. The multipliers can be denoted as r₁ and r₂. So, in this method, the BS Broadcasts (r₁, r₂) at 1410. The UE uses values r₁ and r₂ to deduce (bᵢ, fᵢ, tᵢ) at 1420, since the beginning point of each pilot may be the same. The UE then feeds back CSI values at 1430.

In some embodiments, the AOA/AOD pilots can be removed if an open loop region is allocated by the base station. In this open loop region the base station transmits data to certain users in a spatial diversity mode by cycling through various Tx beams. The cycling pattern is known by all the users in the system. Even through the user is not aware of the data being sent or the CQI of each path, it can still deduce the AOA/AOD from this open loop region using a method such as Music of Esprint.

In some embodiments, the AOA/AOD can be deduced from other channels, for example the PSS/SSS, or CRS. In this case, the pilot can be skipped.

In MMB large numbers of antennas can be used at the base station and mobile station. To estimate the channel it is necessary to isolate the components that are slowly varying vs. those which are rapidly varying. This ensures that minimal pilot overhead is used in channel estimation. The disclosed embodiments provide several ways to accomplish this.

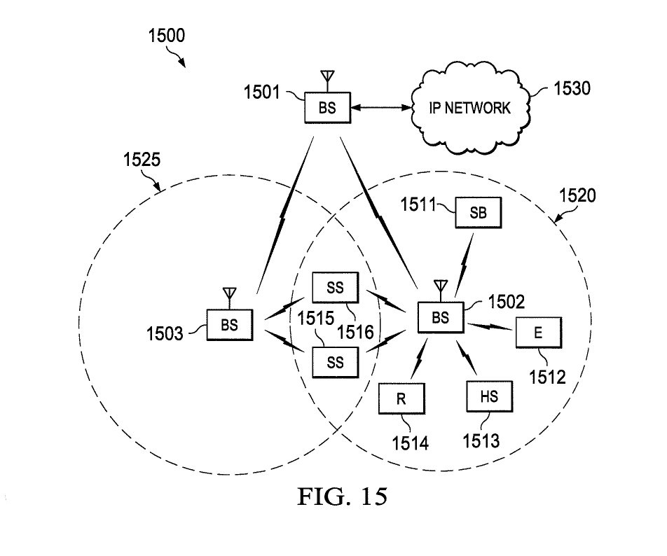

FIG. 15 illustrates a wireless network 1500 according to one embodiment of the present disclosure. The embodiment of wireless network 1500 illustrated in FIG. 15 is for illustration only. Other embodiments of wireless network 1500 could be used without departing from the scope of this disclosure.

The wireless network 1500 includes eNodeB (eNB) 1501, eNB 1502, and eNB 1503. The eNB 1501 communicates with eNB 1502 and eNB 1503. The eNB 1501 also communicates with Internet protocol (IP) network 1530, such as the Internet, a proprietary IP network, or other data network.

Depending on the network type, other well-known terms may be used instead of “eNodeB,” such as “base station” or “access point”. For the sake of convenience, the term “eNodeB” shall be used herein to refer to the network infrastructure components that provide wireless access to remote terminals. In addition, the term user equipment (UE) is used herein to refer to remote terminals that can be used by a consumer to access services via the wireless communications network. Other well-known terms for the remote terminals include “mobile stations” and “subscriber stations.”

The eNB 1502 provides wireless broadband access to network 1530 to a first plurality of user equipments (UEs) within coverage area 1520 of eNB 1502. The first plurality of UEs includes UE 1511, which may be located in a small business; UE 1512, which may be located in an enterprise; UE 1513, which may be located in a WiFi hotspot; UE 1514, which may be located in a first residence; UE 1515, which may be located in a second residence; and UE 1516, which may be a mobile device, such as a cell phone, a wireless laptop, a wireless PDA, or the like. UEs 1511-1516 may be any wireless communication device, such as, but not limited to, a mobile phone, mobile PDA and any mobile station (MS).

For the sake of convenience, the term “user equipment” or “UE” is used herein to designate any remote wireless equipment that wirelessly accesses an eNB, whether the UE is a mobile device (e.g., cell phone) or is normally considered a stationary device (e.g., desktop personal computer, vending machine, etc.). In other systems, other well-known terms may be used instead of “user equipment”, such as “mobile station” (MS), “subscriber station” (SS), “remote terminal” (RT), “wireless terminal” (WT), and the like.

The eNB 1503 provides wireless broadband access to a second plurality of UEs within coverage area 1525 of eNB 1503. The second plurality of UEs includes UE 1515 and UE 1516. In some embodiments, one or more of eNBs 1501-1503 can communicate with each other and with UEs 1511-1516 using LTE or LTE-A techniques including techniques for: using different pilot designs for millimeter wave broadband as described in embodiments of the present disclosure.

Dotted lines show the approximate extents of coverage areas 1520 and 1525, which are shown as approximately circular for the purposes of illustration and explanation only. It should be clearly understood that the coverage areas associated with base stations, for example, coverage areas 1520 and 1525, may have other shapes, including irregular shapes, depending upon the configuration of the base stations and variations in the radio environment associated with natural and man-made obstructions.

Although FIG. 15 depicts one example of a wireless network 1500, various changes may be made to FIG. 15. For example, another type of data network, such as a wired network, may be substituted for wireless network 1500. In a wired network, network terminals may replace eNBs 1501-1503 and UEs 1511-1516. Wired connections may replace the wireless connections depicted in FIG. 1.

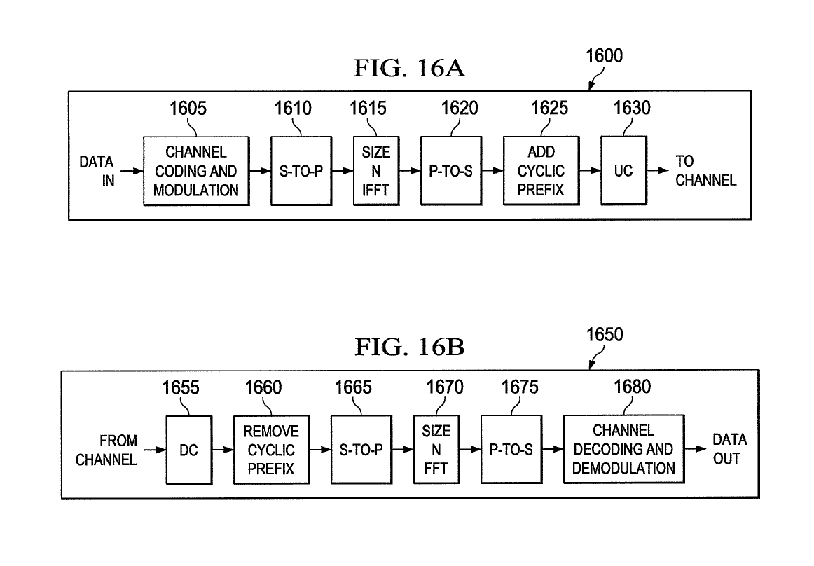

FIG. 16A is a high-level diagram of a wireless transmit path. FIG. 16B is a high-level diagram of a wireless receive path. In FIGS. 16A and 16B, the transmit path 1600 may be implemented, e.g., in eNB 1502 and the receive path 1650 may be implemented, e.g., in a UE, such as UE 1516 of FIG. 15. It will be understood, however, that the receive path 1650 could be implemented in an eNB (e.g. eNB 1502 of FIG. 15) and the transmit path 1600 could be implemented in a UE. In certain embodiments, transmit path 200 and receive path 1650 are configured to using different pilot designs for millimeter wave broadband as described in embodiments of the present disclosure.

Transmit path 1600 comprises channel coding and modulation block 1605, serial-to-parallel (S-to-P) block 1610, Size N Inverse Fast Fourier Transform (IFFT) block 1615, parallel-to-serial (P-to-S) block 1620, add cyclic prefix block 1625, up-converter (UC) 1630. Receive path 1650 comprises down-converter (DC) 1655, remove cyclic prefix block 1660, serial-to-parallel (S-to-P) block 1665, Size N Fast Fourier Transform (FFT) block 1670, parallel-to-serial (P-to-S) block 1675, channel decoding and demodulation block 1680.

At least some of the components in FIGS. 16A and 16B may be implemented in software while other components may be implemented by configurable hardware (e.g., a processor) or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In transmit path 1600, channel coding and modulation block 1605 receives a set of information bits, applies coding (e.g., LDPC coding) and modulates (e.g., Quadrature Phase Shift Keying (QPSK) or Quadrature Amplitude Modulation (QAM)) the input bits to produce a sequence of frequency-domain modulation symbols. Serial-to-parallel block 1610 converts (i.e., de-multiplexes) the serial modulated symbols to parallel data to produce N parallel symbol streams where N is the IFFT/FFT size used in eNB 1502 and UE 1516. Size N IFFT block 1615 then performs an IFFT operation on the N parallel symbol streams to produce time-domain output signals. Parallel-to-serial block 1620 converts (i.e., multiplexes) the parallel time-domain output symbols from Size N IFFT block 1615 to produce a serial time-domain signal. Add cyclic prefix block 1625 then inserts a cyclic prefix to the time-domain signal. Finally, up-converter 1630 modulates (i.e., up-converts) the output of add cyclic prefix block 1625 to RF frequency for transmission via a wireless channel. The signal may also be filtered at baseband before conversion to RF frequency.

The transmitted RF signal arrives at UE 116 after passing through the wireless channel and reverse operations to those at eNB 1502 are performed. Down-converter 1655 down-converts the received signal to baseband frequency and remove cyclic prefix block 1660 removes the cyclic prefix to produce the serial time-domain baseband signal. Serial-to-parallel block 1665 converts the time-domain baseband signal to parallel time domain signals. Size N FFT block 1670 then performs an FFT algorithm to produce N parallel frequency-domain signals. Parallel-to-serial block 1675 converts the parallel frequency-domain signals to a sequence of modulated data symbols. Channel decoding and demodulation block 1680 demodulates and then decodes the modulated symbols to recover the original input data stream.

Each of eNBs 1501-1503 may implement a transmit path that is analogous to transmitting in the downlink to UEs 1511-1516 and may implement a receive path that is analogous to receiving in the uplink from UEs 1511-1516. Similarly, each one of UEs 1511-1516 may implement a transmit path corresponding to the architecture for transmitting in the uplink to eNBs 1501-1503 and may implement a receive path corresponding to the architecture for receiving in the downlink from eNBs 1501-1503.

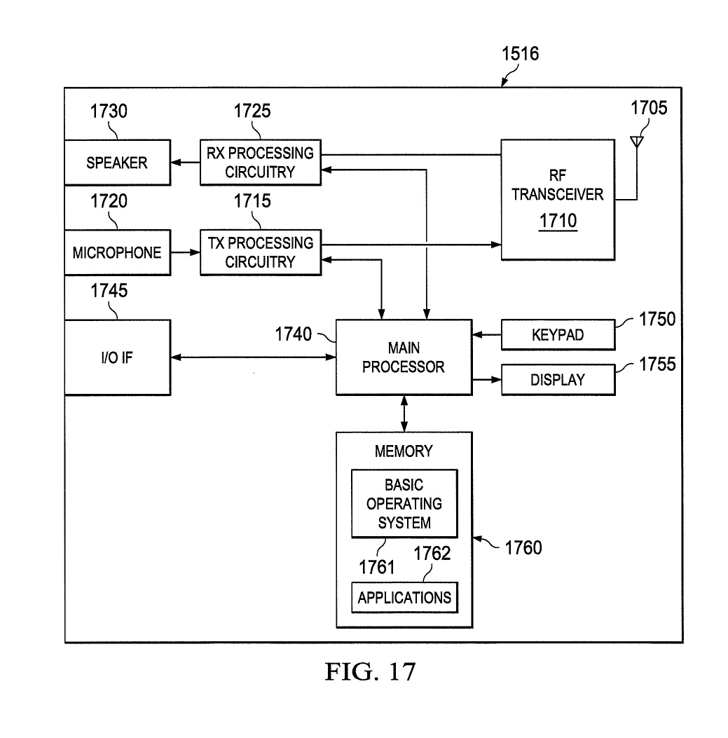

FIG. 17 illustrates a subscriber station according to embodiments of the present disclosure. The embodiment of subscribe station, such as UE 1516, illustrated in FIG. 17 is for illustration only. Other embodiments of the wireless subscriber station could be used without departing from the scope of this disclosure.

UE 1516 comprises antenna 1705, radio frequency (RF) transceiver 1710, transmit (TX) processing circuitry 1715, microphone 1720, and receive (RX) processing circuitry 1725. SS 116 also comprises speaker 1730, main processor 1740, input/output (I/O) interface (IF) 1745, keypad 1750, display 1755, and memory 1760. Memory 1760 further comprises basic operating system (OS) program 1761 and a plurality of applications 1762. The plurality of applications can include one or more of resource mapping tables (Tables 1-10 described in further detail herein below).

Radio frequency (RF) transceiver 1710 receives from antenna 1705 an incoming RF signal transmitted by a base station of wireless network 1500. Radio frequency (RF) transceiver 1710 down-converts the incoming RF signal to produce an intermediate frequency (IF) or a baseband signal. The IF or baseband signal is sent to receiver (RX) processing circuitry 1725 that produces a processed baseband signal by filtering, decoding, and/or digitizing the baseband or IF signal. Receiver (RX) processing circuitry 1725 transmits the processed baseband signal to speaker 1730 (i.e., voice data) or to main processor 1740 for further processing (e.g., web browsing).

Transmitter (TX) processing circuitry 1715 receives analog or digital voice data from microphone 1720 or other outgoing baseband data (e.g., web data, e-mail, interactive video game data) from main processor 1740. Transmitter (TX) processing circuitry 1715 encodes, multiplexes, and/or digitizes the outgoing baseband data to produce a processed baseband or IF signal. Radio frequency (RF) transceiver 1710 receives the outgoing processed baseband or IF signal from transmitter (TX) processing circuitry 1715. Radio frequency (RF) transceiver 1710 up-converts the baseband or IF signal to a radio frequency (RF) signal that is transmitted via antenna 1705.

In certain embodiments, main processor 1740 is a microprocessor or microcontroller. Memory 1760 is coupled to main processor 1740. According to some embodiments of the present disclosure, part of memory 1760 comprises a random access memory (RAM) and another part of memory 1760 comprises a Flash memory, which acts as a read-only memory (ROM).

Main processor 1740 executes basic operating system (OS) program 1761 stored in memory 1760 in order to control the overall operation of wireless subscriber station 1516. In one such operation, main processor 1740 controls the reception of forward channel signals and the transmission of reverse channel signals by radio frequency (RF) transceiver 1710, receiver (RX) processing circuitry 1725, and transmitter (TX) processing circuitry 1715, in accordance with well-known principles.

Main processor 1740 is capable of executing other processes and programs resident in memory 1760, such as operations for determining a new location for one or more of a DMRS or PSS/SSS as described in embodiments of the present disclosure. Main processor 1740 can move data into or out of memory 1760, as required by an executing process. In some embodiments, the main processor 1740 is configured to execute a plurality of applications 1762, such as applications for using different pilot designs for millimeter wave broadband. The main processor 1740 can operate the plurality of applications 1762 based on OS program 1761 or in response to a signal received from BS 1502. Main processor 1740 is also coupled to I/O interface 1745. I/O interface 1745 provides subscriber station 1516 with the ability to connect to other devices such as laptop computers and handheld computers. I/O interface 1745 is the communication path between these accessories and main controller 1740.

Main processor 1740 is also coupled to keypad 1750 and display unit 1755. The operator of subscriber station 1516 uses keypad 1750 to enter data into subscriber station 1516. Display 1755 may be a liquid crystal display capable of rendering text and/or at least limited graphics from web sites. Alternate embodiments may use other types of displays.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A transmitter in a wireless network configured to:
utilize a pilot design and channel estimation strategy to reduce pilot overhead, the pilot design based on a channel decomposition of the channel in a ray tracing channel model.

2. The transmitter of claim 1, further configured to:
assign a first tier pilot to a first set of resource blocks;
assign a second tier pilot to second set of resource blocks;
assign a third tier pilot in a third set of resource blocks, wherein when two of the pilots are assigned to a common resource block, the lower tier pilot is given preference over the higher tier pilot; and
transmit each of the first tier pilot, the second tier pilot, and the third tier pilot to a user equipment.

3. The transmitter of claim 1, further configured to broadcast from a base station information relating to the pilot structure.

4. The transmitter of claim 3, further configured to broadcast a repetition value of a pilot in time and frequency.

5. The transmitter of claim 1, wherein the channel decomposition is based on:
$$H = [ \begin{matrix}1 & 1 & … & 1 \\ {e}^{j {θ}_{1}} & {e}^{j {θ}_{2}} & … & {e}^{j {θ}_{p}} \\ ⋮ & ⋮ & ⋮ & ⋮ \\ {e}^{( {n}_{R} - 1 ) j {θ}_{1}} & {e}^{( {n}_{R} - 1 ) j {θ}_{2}} & … & {e}^{( {n}_{R} - 1 ) j {θ}_{P}}\end{matrix} ] [ \begin{matrix}{h}_{1} & 0 & … & 0 \\ 0 & {h}_{2} & … & 0 \\ ⋮ & ⋮ & ⋮ & ⋮ \\ 0 & 0 & … & {h}_{p}\end{matrix} ] [ \begin{matrix}1 & {e}^{j {θ}_{1}} & … & {e}^{( {n}_{t} - 1 ) j {θ}_{1}} \\ 1 & {e}^{j {θ}_{2}} & … & {e}^{( {n}_{t} - 1 ) j {θ}_{2}} \\ ⋮ & ⋮ & ⋮ & ⋮ \\ 1 & {e}^{j {θ}_{p}} & … & {e}^{( {n}_{t} - 1 ) j {θ}_{p}}\end{matrix} ]$$

6. A wireless network configured to:
transmit pilot signals in a resource block using a plurality of antennas, wherein the number of pilot signals in the resource block is less than a number of antennas used to transmit the pilot signals in the resource block.

7. The wireless network of claim 6, further configured to:
assign a first tier pilot to a first set of resource blocks;
assign a second tier pilot to second set of resource blocks;
assign a third tier pilot in a third set of resource blocks, wherein when two of the pilots are assigned to a common resource block, the lower tier pilot is given preference over the higher tier pilot; and
transmit each of the first tier pilot, the second tier pilot, and the third tier pilot to a user equipment.

8. The wireless network of claim 6, further configured to:
broadcast, from a base station, information relating to the pilot structure,
receiving the information at the user equipment;
determine the pilot structure with the information broadcast from the base station; and
return CSI values from the user equipment to the base station.

9. A method of using a three tiered pilot design in a millimeter wave broadband (MMB) wireless network to estimate channel state information (CSI), comprising:
assigning a first tier pilot to a first set of resource blocks;
assigning a second tier pilot to second set of resource blocks;
assigning a third tier pilot in a third set of resource blocks, wherein when two of the pilots are assigned to a common resource block, the lower tier pilot is given preference over the higher tier pilot; and
transmitting each of the first tier pilot, the second tier pilot, and the third tier pilot to a user equipment.

10. The method according to claim 9, wherein the first tier pilot is an angle of departure (AOD) pilot, the second tier pilot is an angle of arrival (AOA) pilot, and the third tier pilot is a CSI pilot.

11. The method according to claim 9, wherein at least one pilot is assigned to each resource block.

12. The method according to claim 9, wherein each pilot tier is assigned with a given starting resource block, and a given interval between pilots.

13. A method of establishing a pilot structure between a base station and a UE, comprising:
broadcasting from the base station information relating to the pilot structure;
receiving the information at the user equipment;
determining the pilot structure with the information broadcast from the base station; and
returning CSI values from the user equipment to the base station.

14. The method according to claim 13, wherein broadcasting from the base station includes broadcasting a number of RF chains used for a pilot, and further wherein determining the pilot structure includes using the value of the number of RF chains to deduce a base station precoder hopping pattern.

15. The method according to claim 13, wherein broadcasting from the base station includes broadcasting a single parameter P, and further wherein determining the pilot structure includes decoding at least three parameters from P.

16. The method according to claim 13, wherein broadcasting from the base station includes broadcasting a repetition of a pilot in time and frequency, and wherein determining the pilot structure includes using the values of the repetition of a pilot in time and frequency to locate a CSI pilot and determine a receiver beamforming strategy.

17. The method according to claim 13, wherein broadcasting from the base station includes broadcasting a plurality of parameters for a plurality of tiers of pilots.

18. The method according to claim 13, wherein broadcasting from the base station includes broadcasting a plurality of parameters for a plurality of tiers of pilots.

19. The method according to claim 13, wherein broadcasting from the base station includes broadcasting two parameters for a plurality of tiers of pilots, and wherein determining the pilot structure includes using the two parameters to deduce a pilot structure for the plurality of tiers of pilots.

20. The method according to claim 13, wherein the plurality of tiers of pilots includes a pilot for determining an angle of arrival pilot, an angle of departure pilot, and a channel state information pilot.
